(19) United States
(12) Patent Application Publication
(10) Pub. No.: US 2014/0232507 A1
(43) Pub. Date: Aug. 21, 2014

(54) POWDER MAGNETIC CORE AND PRODUCTION METHOD FOR SAME

(71) Applicant: PANASONIC CORPORATION, Osaka (JP)

(72) Inventors: Shota Nishio, Osaka (JP); Takeshi Takahashi, Kyoto (JP); Junichi Kotani, Hyogo (JP)

(73) Assignee: PANASONIC CORPORATION, Osaka (JP)

(21) Appl. No.: 14/346,211

(22) PCT Filed: Oct. 1, 2012
(86) PCT No.: PCT/JP2012/006267

§ 371 Date: Mar. 20, 2014

(30) Foreign Application Priority Data
Oct. 3, 2011 (JP) 2011-219005

(51) Int. Cl. H01F 41/02; H01F 27/255

(52) U.S. Cl. CPC H01F 41/0246; H01F 27/255
USPC 336/233; 419/10

(57) ABSTRACT

A production method for a powder magnetic core includes: mixing soft-magnetic metal powder with silicone resin including at least one functional group selected from carboxyl groups, mercapto groups, amino groups, and silanol groups for forming a mixture in which a surface of the soft-magnetic metal powder is coated with the silicone resin; drying the mixture for forming dry powder; pressurizing the dry powder for forming a compact; and heat-treating the compact.

### TECHNICAL FIELD

The present invention relates to a powder magnetic core used for inductance components such as an inductor, a choke coil, and a transformer, and to a production method for the same.

### BACKGROUND ART

Recently, as electronic apparatuses have become smaller in size and have had larger electric current, inductance components used for electronic apparatuses have been demanded to be small in size and to be driven under large electric current.

Inductance components are generally formed by inserting magnetic material into a coil. Magnetic material used for the inductance components are roughly divided into ferrite cores and powder magnetic cores. Ferrite cores have small saturation magnetization, and easily cause magnetic saturation. Therefore, magnetic permeability is remarkably reduced under large electric current. As measures for this problem, a method for making it difficult to cause magnetic saturation by increasing a cross-sectional area through which a magnetic flux passes in the ferrite core, or by introducing a gap into the ferrite core have been considered. However, the former method causes size increase of an inductance component. Meanwhile, the latter method may cause leakage magnetic flux from the gap to increase loss of an eddy current, and may cause generation of noise in the peripheral components. Therefore, it is difficult to produce ferrite cores having a small size and capable of being driven under large electric current.

On the contrary, a powder magnetic core produced by compression-molding soft-magnetic metal powder has large saturation magnetization and less reduction of permeability even under large electric current as compared with a ferrite core. Therefore, the powder magnetic core is useful as small inductance components capable of being driven under large electric current.

Furthermore, powder magnetic core is required to have predetermined mechanical strength in order to enhance yield and reliability by suppressing fracture and cracking occurring in manufacture or in use. However, sufficient mechanical strength cannot be obtained only by compression-molding soft-magnetic metal powder.

Therefore, in general, mechanical strength is enhanced by adding thermosetting silicone resin to a powder magnetic core. However, it is difficult to obtain a powder magnetic core having high mechanical strength, excellent magnetic loss property, and magnetic permeability only by adding silicone resin to the powder magnetic core. Therefore, studies for improving additives or production methods have been carried out, and a powder magnetic core whose mechanical strength and magnetic property are improved is disclosed. Prior arts documents regarding to the present invention include PTL 1.

### CITATION LIST

### Patent Literature

PTL 1: Japanese Patent Unexamined Publication No. H7-254522

### SUMMARY OF THE INVENTION

A production method for a powder magnetic core of the present invention includes: mixing soft-magnetic metal powder with silicone resin including at least one functional group selected from carboxyl groups, mercapto groups, amino groups, and silanol groups for forming a mixture in which a surface of the soft-magnetic metal powder is coated with the silicone resin; drying the mixture for forming dry powder; pressurizing the dry powder for forming a compact; and heat-treating the compact.

A powder magnetic core of the present invention is formed by mixing soft-magnetic metal powder and silicone resin with each other to form a mixture in which a surface of the soft-magnetic metal powder is coated with the silicone resin, pressure-molding the mixture, followed by heat treatment. The silicone resin includes at least one functional group selected from carboxyl groups, mercapto groups, amino groups, and silanol groups.

### BRIEF DESCRIPTION OF THE DRAWINGS

FIG. 1 is a flow chart showing a production method for a powder magnetic core in accordance with an exemplary embodiment of the present invention.

### DESCRIPTION OF EMBODIMENTS

According to PTL 1, ferromagnetic metal powder and silicone resin are mixed with each other at two divided times, and heat treatment is carried out after each mixing at different heat-treating temperatures. By setting the heat-treating temperature at the second time to be lower than that at the first time, adhesiveness of silicone resin is enhanced, and mechanical strength is improved. Furthermore, by adding organic titanium, the mechanical strength is further enhanced. However, in such a powder magnetic core, steps and material are increased, thus reducing productivity.

Hereinafter, a powder magnetic core in accordance with this exemplary embodiment is described. A production method for a powder magnetic core in accordance with this exemplary embodiment includes: mixing soft-magnetic metal powder with silicone resin including at least one functional group selected from carboxyl groups, mercapto groups, amino groups, and silanol groups for forming a mixture in which a surface of the soft-magnetic metal powder is coated with the silicone resin; drying the mixture for forming dry powder; pressurizing the dry powder for forming a compact; and heat-treating the compact.

It is preferable that the soft-magnetic metal powder to be used in the powder magnetic core in accordance with this exemplary embodiment has high saturation magnetization from the viewpoint of suppressing magnetic saturation under large electric current. It is preferable that iron is used for the main component. In addition to iron, Fe—Ni alloy powder, Fe—Si alloy powder, and Fe—Al—Si alloy powder in which Ni, Si, Al, or the like, is added in order to enhance the soft magnetism property, are used as soft-magnetic metal powder. However, the powder magnetic core in accordance with this exemplary embodiment is not particularly limited to the above-mentioned material, and any material may be employed as long as it has a high saturation magnetization value.

As the soft-magnetic metal powder, various types of atomized powder such as water atomized powder and gas atomized powder, milled powder, soft-magnetic metal powder such as carbonyl iron dust formed by a chemical synthesis method can be used. An average particle diameter of the soft-magnetic metal powder is preferably 1 μm or more and 100 μm or less. The average particle diameter of 1 μm or more can increase a molding density, and suppress magnetic permeability. The average particle diameter of less than 100 μm can suppress eddy current loss in a high frequency band. It is further preferable that the average particle diameter is 50 μm or less because the eddy current loss can be further suppressed.

Furthermore, a particle shape of the soft-magnetic metal powder is not particularly limited, the shape may be selected from substantially spherical shape, a flat shape, or the like, in accordance with purposes of uses.

The silicone resin of this exemplary embodiment includes at least one functional group selected from carboxyl groups, mercapto groups, amino groups, and silanol groups. Such a functional group has high affinity with respect to a surface of the soft-magnetic metal powder having a hydrophilic property. Therefore, dispersion property of the soft-magnetic metal powder and silicone resin is improved. As a result, a uniform silicone resin coating is formed on a surface of the soft-magnetic metal powder. The soft-magnetic metal powder uniformly coated with silicone resin is pressure-molded so as to obtain a compact. Since the soft-magnetic metal powder is uniformly coated with a silicone resin coating, filling of the soft-magnetic metal powder at the time of pressure-molding is promoted, thus enhancing the magnetic permeability of the powder magnetic core.

Note here that a natural oxide film may be produced on the surface of the soft-magnetic metal powder. In particular, when the soft-magnetic metal powder includes metal having stronger affinity with respect to oxygen as compared with iron (Fe) as a main component, such a metal may be produced on the natural oxide film in a state in which it is dispersed on the surface of the soft-magnetic metal powder. Examples of such metal include Al, Si, and Cr. The powder magnetic core in accordance with this exemplary embodiment may have a natural oxide film produced on the surface of the soft-magnetic metal powder. An effect is exhibited even when the natural oxide film is produced.

The compact is heat-treated at 700° C. or higher and 1000° C. or lower in order to remove distortion after press-molding. At this time, the silicone resin coating coated on the surface of the soft-magnetic metal powder is degraded, and silicon oxide mainly remains. However, since a uniform silicone resin coating is formed at the time of molding, residues mainly including silicon oxide are uniformly formed on the surface of the soft-magnetic metal powder also after heat treatment. The residues function as insulating material that insulates among the soft-magnetic metal powders, which are useful for reducing eddy current loss.

The silicone resin of this exemplary embodiment includes at least one functional group selected from carboxyl groups, mercapto groups, amino groups, and silanol groups. Among them, silicone resin including silanol groups is described specifically. The silanol groups in silicone resin have particularly high reactivity, and cause dehydration-condensation with functional groups such as hydroxyl groups existing on the surface of the soft-magnetic metal powder by heat treatment, and are firmly bonded to the surface of the soft-magnetic metal powder. Furthermore, silanol groups form a strong siloxane bond by dehydration-condensation. Therefore, by adding silicone resin including silanol groups, the soft-magnetic metal powder is bound to the other powder by strong network mainly including a siloxane bond, so that the mechanical strength is enhanced.

Furthermore, hydrolysis groups such as alkoxy groups form silanol groups by hydrolysis. However, even when silicone resin including alkoxy groups is added to the powder magnetic core, and silanol groups are generated by hydrolysis, strength of the powder magnetic core is reduced as compared with the case where silicone resin including silanol groups is added.

This is thought to be because hydrolysis reaction necessary for generating silanol groups is affected by water existing in the atmosphere or on the surface of the soft-magnetic metal powder, so that hydrolysis reaction does not necessarily occur uniformly inside the powder magnetic core.

Therefore, when powder magnetic core is produced by using silicone resin including hydrolysis groups that generate silanol groups by hydrolysis, it is necessary to suppress variation of hydrolysis behavior due to the effect of water existing in the atmosphere or on the surface of the soft-magnetic metal powder. That is to say, in order to enhance reproducibility of product property, measures in manufacture is needed. Measures such as adding material that works as a supply source of water necessary for hydrolysis, and heating in a mixing process of soft-magnetic metal powder and silicone resin in order to promote hydrolysis. However, such measures are not preferable because they cause increase in cost of facility and material and increase of man-hour, thus reducing the productivity.

The powder magnetic core of this exemplary embodiment is less susceptible of water as mentioned above and has excellent productivity, because silicone resin including at least one functional group selected from carboxyl groups, mercapto groups, amino groups, and silanol groups is mixed.

Furthermore, as the hardness of silicone resin of this exemplary embodiment before press-molding is lower, the mechanical strength of the powder magnetic core can be enhanced.

When the hardness of silicone resin before press-molding is low, deformability at the time of molding is high, and filling of the soft-magnetic metal powder is promoted. This increases a filling rate of the soft-magnetic metal powder in the powder magnetic core, so that high magnetic permeability can be obtained. Furthermore, when the soft-magnetic metal powder is higher, air gaps among the soft-magnetic metal powder is reduced, so that binding of the silicone resin among neighboring soft-magnetic metal powder is promoted. Therefore, the mechanical strength of the powder magnetic core is increased.

When the hardness of silicone resin to be added before press-molding has pencil hardness of 4H or less, high mechanical strength is obtained. Note here that the hardness of silicone resin before press-molding is referred to as hardness of the silicone resin coating formed on the surface of the soft-magnetic metal powder. As mentioned later, when a solvent is used in the mixing process, the hardness of silicone resin before press-molding is referred to as hardness of silicone resin coating after the solvent is dried. The pencil hardness of the silicone resin before press-molding is measured after the solvent is removed in the silicone resin coating produced on a film or a base material.

Hereinafter, a production method for a powder magnetic core in accordance with this exemplary embodiment is described. Firstly, soft-magnetic metal powder and silicone resin are mixed with each other. Silicone resin may be used in a solid state or in a liquid state in which the silicone resin is mixed with a solvent. When silicone resin in a solid state or in a liquid state having high viscosity, in order to facilitate mixing of silicone resin with soft-magnetic metal powder, a solvent capable of solving silicone resin may be added. A method for adding of the solvent is not particularly limited, the solvent may be added to the soft-magnetic metal powder at the same time with silicone resin, or a solution obtained by diluting the silicone resin with a solvent may be mixed with the soft-magnetic metal powder. A mixing and dispersing method is not particularly limited, and, for example, various types of ball mills such as a rotary ball mill and a planetary-type ball mill, a V blender, a planetary mixer, or the like, can be used. When a solvent is added, a mixture is dried after mixing in order to remove the solvent. Drying conditions are not particularly limited as long as the solvent to be used can evaporate. When, for example, toluene is used, drying is carried out at 70° C. or higher and 110° C. or lower. However, natural drying may be possible depending upon types of solvents. Furthermore, when a mixture is filled into a mold to be used for press-molding, if the mixture is too large to be filled, milling treatment may be carried out.

Next, the above-mentioned mixture is press-molded. It is preferable that powder bodies (mixtures) to be used in press-molding are classified into 100 μm or more and 500 μm or less in order to enhance fluidity and enhance filling property to the mold. However, the classification is not particularly limited to this range, the classification may be carried out at any particle size, and classification may not be necessary depending upon conditions. Note here that it is preferable that press-molding is carried out at a pressure of 6 ton/cm² or more in order to enhance the density of the compact, and to obtain sufficient mechanical strength, high magnetic permeability, and low magnetic loss. Furthermore, it is preferable that the molding pressure is 20 ton/cm² or less in order to maintain the life of the mold and improve the productivity. In consideration of these things, it is preferable that the molding pressure is 6 ton/cm² or more and 20 ton/cm² or less. Furthermore, it is preferable that fluidity of the powder bodies is enhanced in order to supply powder bodies to a mold to be used for press-molding stably. Therefore, it is desirable that the pencil hardness of the silicone resin before press-molding is 5B or more. When the fluidity of the powder body is improved, it is possible to obtain powder magnetic core with less blockage of powder bodies inside a hopper or a mold, and which is excellent productivity, and has less variation of densities. As mentioned above, in order to obtain high mechanical strength, it is preferable that the pencil hardness of silicone resin is made to be 4H or less. Therefore, in order to obtain high mechanical strength and suitable fluidity, it is preferable that the pencil hardness of silicone resin is 5B or more and 4H or less.

The pencil hardness of the silicone resin before press-molding is measured after the solvent is removed in the silicone resin coating produced on a film or a base material. Drying conditions are not particularly limited as long as the solvent to be used can evaporate in the condition. For example, heating may be carried out at 70° C. or higher and 110° C. or lower for about 30 minutes. The measurement method is carried out with respect to the scratch strength (pencil hardness) by a pencil method, according to the measurement method of JIS K5600-5-4.

Furthermore, it is preferable that an addition amount of silicone resin is preferably 0.01 wt % or more and 5.0 wt % or less with respect to the soft-magnetic metal powder. When the addition amount of silicone resin is made to be 0.01 wt % or more, the mechanical strength of powder magnetic core can be enhanced. When the addition amount of silicone resin is made to be 5.0 wt % or less, low magnetic loss and high magnetic permeability can be achieved. Furthermore, it is further preferable that the addition amount of silicone resin is made to be 0.01 wt % or more and 1 wt % because lower magnetic loss and higher magnetic permeability can be obtained.

Next, since distortion accumulated on the powder magnetic core after press-molding causes increase in the magnetic loss of the powder magnetic core, heat treatment is carried out in order to remove distortion. Therefore, it is preferable that heat treatment after press-molding is carried out at 700° C. or higher. Furthermore, it is preferable that heat-treating temperature is carried out at 1000° C. or lower because the insulation property among soft-magnetic metal powder is reduced and eddy current loss is increased when the heat-treating temperature is higher than 1000° C. Furthermore, it is preferable that atmosphere of the heat treatment is nonoxidative atmosphere in order to suppress reduction of magnetic property due to oxidation of the metal magnetic powder. For example, inert atmospheres such as an argon gas, a nitrogen gas, and a helium gas are preferable.

Furthermore, the powder magnetic core in accordance with this exemplary embodiment may include other material as long as it includes soft-magnetic metal powder and silicone resin including at least one functional group selected from carboxyl groups, mercapto groups, amino groups, and silanol groups. Examples of material to be added include insulating auxiliary agents enabling heat-treatment at high temperatures, for example, oxides such as aluminum oxide, silicon oxide, titanium oxide, and magnesium oxide, or nitrides such as boron nitride, aluminum nitride, and silicon nitride, or minerals such as mica, talc, and kaolin. Furthermore, in order to improve moldability of a powder magnetic core, and handling property of a compact, resin such as butyral resin, epoxy resin, acrylic resin, and ethylcellulose, in addition to silicone resin, may be added as a binder. Furthermore, in order to promote a cross-linking reaction of silicone resin, titanate-based or aluminum-based curing catalysts, various metal stearates as lubricant for improving filling property may be added.

Hereinafter, Examples of a powder magnetic core in accordance with this exemplary embodiment are described.

### Example 1

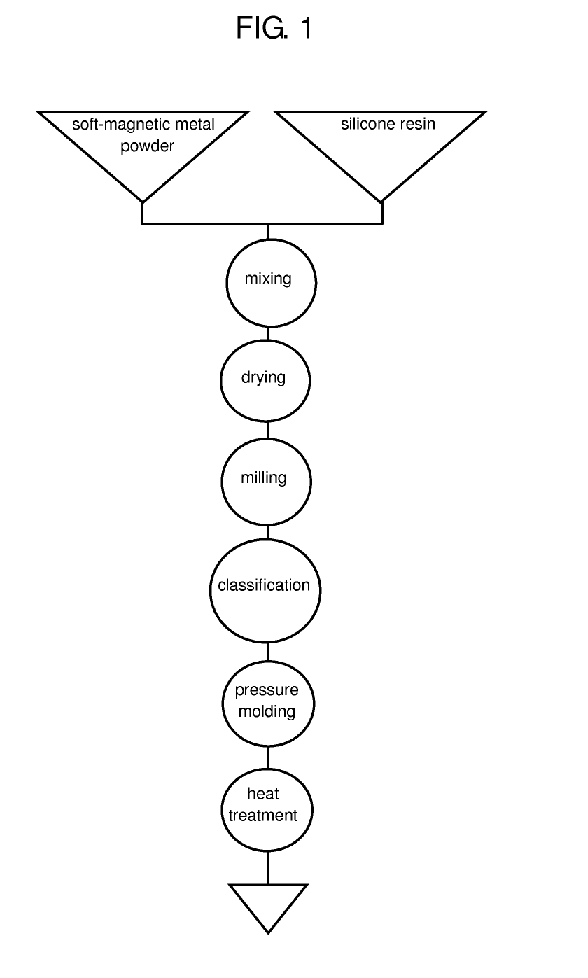

FIG. 1 is a flow chart showing a production method for a powder magnetic core in accordance with this Example. However, as mentioned above, depending upon conditions, milling and classification may not be needed. In this Example, as soft-magnetic metal powder, Fe—Al—Si alloy powder produced by a gas atomization method and having an average particle diameter of 30 μm is used. Silicone resin including functional groups such as mercapto groups, carboxyl groups, silanol groups, and amino groups, respectively, is mixed to the soft-magnetic metal powder so as to produce samples Nos. 1 to 4 (see, Table 1).

As comparative examples, samples Nos. 5 and 6 in which silicone resin including a phenyl group and a vinyl group, respectively, is added to the soft-magnetic metal powder are produced. Furthermore, as a comparative example, sample No. 7, in which 0.2 wt % of silane coupling agent is added, a small amount of ethanol is mixed therewith, and silicone resin including a phenyl group are mixed with the soft-magnetic metal powder, is produced. Any samples are produced by adding silicone resin in an addition amount of 1.0 wt % with respect to the soft-magnetic metal powder, and further adding a small amount of toluene thereto.

TABLE 1

| | | | | | relative | |
|---|---|---|---|---|---|---|
| | | silane | bending | magnetic | magnetic | |
| S. | functional | coupling | strength | loss | perme- | |
| No | group | treatment | (MPa) | (kW · m⁻³) | ability | — |
| 1 | mercapto | not carried | 2.2 | 362 | 32 | Ex |
| | group | out | | | | |
| 2 | carboxyl | not carried | 2.6 | 350 | 33 | Ex |
| | group | out | | | | |
| 3 | silanol | not carried | 4.8 | 335 | 35 | Ex |
| | group | out | | | | |
| 4 | amino | not carried | 2.1 | 348 | 33 | Ex |
| | group | out | | | | |
| 5 | phenyl | not carried | 0.8 | 1198 | 25 | Co. Ex |
| | group | out | | | | |
| 6 | vinyl | not carried | 0.6 | 1157 | 26 | Co. Ex |
| | group | out | | | | |
| 7 | phenyl | carried | 1.1 | 851 | 28 | Co. Ex |
| | group | out | | | | |

S. No = sample number
Ex = Example
Co. Ex = Comparative Example

Each of the above-mentioned samples is dried at 100° C. for 30 minutes, the dried product is milled, and then classified into 100 μm or more and 500 μm or less so as to obtain a powder body for molding. Each sample is molded into a toroidal shape having an outer diameter of 14 mm, an inner diameter of 10 mm, and a thickness of 2 mm, at a pressure of 10 ton/cm², and heat-treated at 700° C. for 30 minutes. Then, magnetic property of the powder magnetic core of each sample is measured. The magnetic loss is measured by using an alternating BH curve measurement device in the conditions of 100 mT and 120 kHz. The relative magnetic permeability is obtained from an inductance value measured by using an LCR meter in the conditions of 120 kHz and superposition magnetic field of 52 Oe. Furthermore, the bending strength is obtained as an indicator of the mechanical strength, in which a plate-like sample having a length of 18 mm, a width of 5 mm, and a thickness of 4 mm is molded at 10 ton/cm², heat-treated at 700° C. for 30 minutes, and subjected to a destruction test by the 3-point bending test, and the bending strength is calculated based on the following mathematical formula Math. 1.

$$S = \frac{3 PL}{2 {t}^{2} w} \qquad [ Math . 1 ]$$

P: breaking load (N)
L: distance between supports of jig (mm)
t: thickness of test piece (mm)
w: width of test piece (mm)

In the 3-point bending test, the dropping rate is made to be 1.5 mm/sec. Measurement results of the bending strength, the magnetic loss, and the relative magnetic permeability in each sample are shown in Table 1. In order to secure excellent handling property at the time of production, bending strength of not less than 1.0 MPa is necessary in the bending strength measurement method.

Samples Nos. 1 to 4 using silicone resin including functional groups such as mercapto groups, carboxyl groups, silanol groups, and amino groups show high mechanical strength, low magnetic loss, high relative magnetic permeability. Among them, sample No. 3 using silicone resin including a silanol group shows particularly excellent mechanical strength and low magnetic loss.

Functional groups used for the silicone resin of samples Nos. 1 to 4 are hydrophilic groups, and have high affinity with respect to soft-magnetic metal powder, so that excellent dispersing property is obtained. On the other hand, functional groups such as phenyl groups and vinyl groups used for the silicone resin of samples Nos. 5 and 6 of Comparative Examples are hydrophobic groups and have low affinity with respect to the soft-magnetic metal powder. Therefore, they have low dispersing property with respect to the surfaces of the soft-magnetic metal powder, resulting in weakening the mechanical strength, increasing magnetic loss, and reducing relative magnetic permeability. Furthermore, sample No. 7 as Comparative Example, which has been subjected to silane coupling treatment, shows improved mechanical strength, magnetic loss, and relative magnetic permeability as compared with sample No. 5 using silicone resin including a phenyl group, but shows lower mechanical strength, higher magnetic loss, and lower relative magnetic permeability as compared with samples Nos. 1 to 4.

Note here that, silicone resin including mercapto groups, carboxyl groups, silanol groups, and amino groups, which are hydrophilic groups, among the functional groups have effects described in Table 1, but all the hydrophilic groups do not necessarily exhibit the same effects.

### Example 2

In this Example, as soft-magnetic metal powder, Fe—Al—Si alloy powder produced by a water atomization method and having an average particle diameter of 10 μm is used. Silicone resin including functional groups such as mercapto groups, carboxyl groups, silanol groups, and amino groups, respectively, is mixed to the soft-magnetic metal powder so as to produce samples Nos. 1 to 48 (see, Tables 2-1 and 2-2).

As comparative examples, samples Nos. 49 and 50 in which silicone resin including a phenyl group is added in the soft-magnetic metal powder are produced.

TABLE 2-1

| | functional group | addition | | | | |
|---|---|---|---|---|---|---|
| | included in | amount of | bending | magnetic | relative | |
| S. | added silicone | silicone | strength | loss | magnetic | |
| No. | resin | resin (wt %) | (MPa) | (kW · m⁻³) | permeability | — |
| 1 | mercapto group | 0.005 | 0.7 | 511 | 33 | Ex. |
| 2 | mercapto group | 0.007 | 0.8 | 516 | 33 | Ex. |
| 3 | mercapto group | 0.01 | 2.8 | 491 | 32 | Ex. |
| 4 | mercapto group | 0.05 | 3.0 | 505 | 31 | Ex. |
| 5 | mercapto group | 0.20 | 3.2 | 502 | 31 | Ex. |
| 6 | mercapto group | 0.30 | 3.2 | 496 | 31 | Ex. |
| 7 | mercapto group | 0.50 | 3.4 | 512 | 30 | Ex. |
| 8 | mercapto group | 1.00 | 4.0 | 513 | 30 | Ex. |
| 9 | mercapto group | 1.10 | 4.5 | 729 | 25 | Ex. |
| 10 | mercapto group | 3.00 | 4.8 | 747 | 25 | Ex. |
| 11 | mercapto group | 5.00 | 5.8 | 796 | 24 | Ex. |
| 12 | mercapto group | 5.10 | 5.8 | 1569 | 21 | Ex. |
| 13 | carboxyl group | 0.005 | 0.8 | 583 | 34 | Ex. |
| 14 | carboxyl group | 0.007 | 0.9 | 568 | 34 | Ex. |
| 15 | carboxyl group | 0.01 | 3.7 | 532 | 34 | Ex. |
| 16 | carboxyl group | 0.05 | 4.1 | 519 | 34 | Ex. |
| 17 | carboxyl group | 0.20 | 4.4 | 527 | 33 | Ex. |
| 18 | carboxyl group | 0.30 | 4.5 | 542 | 33 | Ex. |
| 19 | carboxyl group | 0.50 | 4.6 | 532 | 33 | Ex. |
| 20 | carboxyl group | 1.00 | 5.5 | 544 | 33 | Ex. |
| 21 | carboxyl group | 1.10 | 6.3 | 800 | 26 | Ex. |
| 22 | carboxyl group | 3.00 | 6.6 | 803 | 25 | Ex. |
| 23 | carboxyl group | 5.00 | 8.1 | 811 | 24 | Ex. |
| 24 | carboxyl group | 5.10 | 8.3 | 1465 | 22 | Ex. |
| 25 | silanol group | 0.005 | 1.0 | 428 | 37 | Ex. |
| 26 | silanol group | 0.007 | 1.0 | 429 | 37 | Ex. |
| 27 | silanol group | 0.01 | 5.5 | 429 | 37 | Ex. |
| 28 | silanol group | 0.05 | 6.0 | 430 | 37 | Ex. |
| 29 | silanol group | 0.20 | 6.4 | 432 | 36 | Ex. |
| 30 | silanol group | 0.30 | 6.5 | 435 | 36 | Ex. |
| 31 | silanol group | 0.50 | 6.7 | 440 | 36 | Ex. |

S. No = sample number
Ex = Example
Co. Ex = Comparative Example

TABLE 2-2

| | functional | addition | | | | |
|---|---|---|---|---|---|---|
| | group | amount of | | | | |
| | included in | silicone | bending | magnetic | relative | |
| S. | added silicone | resin | strength | loss | magnetic | |
| No. | resin | (wt %) | (MPa) | (kW · m⁻³) | permeability | — |
| 32 | silanol group | 1.00 | 7.9 | 449 | 36 | Ex. |
| 33 | silanol group | 1.10 | 9.0 | 689 | 30 | Ex. |
| 34 | silanol group | 3.00 | 9.5 | 708 | 30 | Ex. |
| 35 | silanol group | 5.00 | 11.5 | 732 | 29 | Ex. |
| 36 | silanol group | 5.10 | 11.5 | 1382 | 25 | Ex. |
| 37 | amino group | 0.005 | 0.6 | 558 | 34 | Ex. |
| 38 | amino group | 0.007 | 0.8 | 550 | 34 | Ex. |
| 39 | amino group | 0.01 | 4.0 | 542 | 34 | Ex. |
| 40 | amino group | 0.05 | 4.2 | 544 | 34 | Ex. |
| 41 | amino group | 0.20 | 4.4 | 521 | 33 | Ex. |
| 42 | amino group | 0.30 | 4.6 | 502 | 33 | Ex. |
| 43 | amino group | 0.50 | 5.1 | 515 | 32 | Ex. |
| 44 | amino group | 1.00 | 6.2 | 516 | 32 | Ex. |
| 45 | amino group | 1.10 | 6.6 | 762 | 25 | Ex. |
| 46 | amino group | 3.00 | 7.0 | 771 | 23 | Ex. |
| 47 | amino group | 5.00 | 8.3 | 848 | 22 | Ex. |
| 48 | amino group | 5.10 | 8.5 | 1567 | 20 | Ex. |
| 49 | phenyl group | 0.01 | 0.1 | 1582 | 25 | Co. Ex. |
| 50 | phenyl group | 5.00 | 0.6 | 2349 | 24 | Co. Ex. |

S. No = sample number
Ex = Example
Co. Ex = Comparative Example

In any samples, mixtures are produced by mixing 1.0 wt % of epoxy resin and a small amount of toluene with respect to the soft-magnetic metal powder in order to improve the handling property of the compact. Furthermore, the mixtures are dried at 95° C. for 60 minutes, dried products are milled, and classified into 100 μm or more and 500 μm or less so as to be formed into a powder body for molding.

Each sample is molded into a toroidal shape having an outer diameter of 14 mm, an inner diameter of 10 mm, and a thickness of 2 mm, at a pressure of 12 ton/cm², and heat-treated at 900° C. for 30 minutes. Then, magnetic property of the powder magnetic core of each sample is measured. The magnetic loss is measured by using an alternating BH curve measurement device in the conditions of 100 mT and 120 kHz. The relative magnetic permeability is obtained from an inductance value measured by using an LCR meter in the conditions of 120 kHz and superposition magnetic field of 52 Oe. Furthermore, the bending strength is obtained as an indicator of the mechanical strength, in which a plate-like sample having a length of 18 mm, a width of 5 mm, and a thickness of 4 mm is molded at 12 ton/cm², heat-treated at 900° C. for 30 minutes, and subjected to a destruction test by the 3-point bending test. Note here that the bending strength is measured by the same method as in Example 1. Evaluation results are shown in Tables 2-1 and 2-2.

From Tables 2-1 and 2-2, samples Nos. 1 to 48 using silicone resin including mercapto groups, carboxyl groups, silanol groups, and amino groups show more excellent mechanical strength and magnetic loss property as compared with samples Nos. 49 and 50 of the Comparative Examples. As is apparent from samples Nos. 3 to 11, samples Nos. 15 to 23, samples Nos. 27 to 35, and samples Nos. 39 to 47, when silicone resin is added to the soft-magnetic metal powder in 0.01 wt % or more and 5.0 wt % or less, excellent mechanical strength, low magnetic loss, and high relative magnetic permeability are obtained. Furthermore, when the addition amount of silicone resin is 0.01 wt % or more and 1.0 wt % or less, more excellent magnetic loss property and relative magnetic permeability are obtained.

### Example 3

In Examples, as soft-magnetic metal powder, Fe—Ni alloy powder produced by a water atomization method and having an average particle diameter of 10 μm is used. Samples Nos. 1 to 10 are produced by mixing 0.1 wt % of silicone resin including a silanol group and a small amount of toluene with the soft-magnetic metal powder. In samples Nos. 11 to 12, the pencil hardness of silicone resin to be mixed is changed from 6B to 6H (see Table 3).

As Comparative Examples, samples Nos. 11 and 12 are produced by mixing 0.1 wt % of silicone resin including a vinyl group and a small amount of toluene with the soft-magnetic metal powder. In samples Nos. 1 to 10, the pencil hardness of silicone resin to be mixed is 6B and 6H.

TABLE 3

| | functional | | | | | |
|---|---|---|---|---|---|---|
| | group | pencil | | | | |
| | included in | hardness of | | | | |
| | added | added | | magnetic | relative | |
| S. | silicone | silicone | bending | loss | magnetic | |
| No. | resin | resin | strength (MPa) | (kW · m⁻³) | permeability | — |
| 1 | silanol | 6B | 6.3 | 703 | 58 | Ex. |
| | group | | | | | |
| 2 | silanol | 5B | 6.2 | 705 | 58 | Ex. |
| | group | | | | | |
| 3 | silanol | 2B | 6.0 | 712 | 58 | Ex. |
| | group | | | | | |
| 4 | silanol | 1B | 5.8 | 729 | 58 | Ex. |
| | group | | | | | |
| 5 | silanol | HB | 5.5 | 731 | 57 | Ex. |
| | group | | | | | |
| 6 | silanol | F | 5.4 | 743 | 57 | Ex. |
| | group | | | | | |
| 7 | silanol | H | 3.5 | 868 | 52 | Ex. |
| | group | | | | | |
| 8 | silanol | 4H | 3.4 | 897 | 51 | Ex. |
| | group | | | | | |
| 9 | silanol | 5H | 1.5 | 983 | 48 | Ex. |
| | group | | | | | |
| 10 | silanol | 6H | 1.3 | 988 | 48 | Ex. |
| | group | | | | | |
| 11 | vinyl group | 6B | 0.6 | 1135 | 42 | Co. Ex. |
| 12 | vinyl group | 6H | 0.4 | 1197 | 42 | Co. Ex. |

S. No = sample number
Ex = Example
Co. Ex = Comparative Example

Evaluation of the pencil hardness is carried out by the scratch strength (pencil hardness) by a pencil method according to the measurement method of JIS K5600-5-4 by using samples obtained by coating the above-mentioned samples on a film and drying a solvent at 80° C. for 60 minutes. These samples are milled and then classified into 100 μm or more and 500 μm or less so as to obtain a powder body for molding.

Each sample is molded into a toroidal shape having an outer diameter of 14 mm, an inner diameter of 10 mm, and a thickness of 2 mm, at a pressure of 8 ton/cm², and heat-treated at 750° C. for 60 minutes. Then, magnetic property of the powder magnetic core of each sample is measured. The magnetic loss is measured by using an alternating BH curve measurement device in the conditions of 100 mT and 120 kHz. The relative magnetic permeability is obtained from an inductance value measured by using an LCR meter in the conditions of 120 kHz and superposition magnetic field of 52 Oe. Furthermore, the bending strength is obtained as an indicator of the mechanical strength, in which a plate-like sample having a length of 18 mm, a width of 5 mm, and a thickness of 4 mm is molded at 8 ton/cm², heat-treated at 750° C. for 60 minutes, and subjected to a destruction test by the 3-point bending test. Note here that the bending strength is measured by the same method as in Example 1. Evaluation results are shown in Table 3.

From Table 3, Examples of samples Nos. 1 to 10 using silicone resin including silanol groups show high mechanical strength, low magnetic loss, and high relative magnetic permeability. When samples Nos. 1 to 8 are compared with samples Nos. 9 and 10, samples Nos. 1 to 8 in which the pencil hardness of silicone resin is 4H or less show excellent mechanical strength and low magnetic loss. As shown in samples Nos. 1 to 6, when the pencil hardness is made to be F or less, further excellent bending strength can be obtained. As mentioned above, when the pencil hardness of silicone resin is 4H or less, high mechanical strength and magnetic property are exhibited. Furthermore, when the pencil hardness of silicone resin is further F or less, powder magnetic core having excellent mechanical strength and magnetic property can be obtained.

### Example 4

In this Example, as soft-magnetic metal powder, Fe—Si alloy powder produced by a water atomization method and having an average particle diameter of 12 μm is used. Samples Nos. 1 to 6 are produced by mixing 0.2 wt % of silicone resin including carboxyl groups, 1.0 wt % of acrylic resin, and a small amount of xylene with the soft-magnetic metal powder. The acrylic resin is used for securing handling property of the compact.

These samples (mixtures) are dried at 100° C. for 30 minutes, and the dried product is milled, and then classified into 100 μm or more and 500 μm or less so as to obtain a powder body for molding.

Each sample is molded into a toroidal shape having an outer diameter of 14 mm, an inner diameter of 10 mm, and a thickness of 2 mm, at molding pressures described in Table 4, and heat-treated at 800° C. for 60 minutes.

TABLE 4

| | functional group | | | | | |
|---|---|---|---|---|---|---|
| | included in | molding | bending | magnetic | relative | |
| S. | added silicone | pressure | strength | loss | magnetic | |
| No. | resin | (ton · cm⁻²) | (MPa) | (kW · m⁻³) | permeability | — |
| 1 | carboxyl group | 6 | 1.2 | 1285 | 48 | Ex. |
| 2 | carboxyl group | 7 | 1.3 | 1280 | 49 | Ex. |
| 3 | carboxyl group | 8 | 1.5 | 1267 | 49 | Ex. |
| 4 | carboxyl group | 9 | 1.5 | 1230 | 50 | Ex. |
| 5 | carboxyl group | 10 | 1.6 | 1203 | 52 | Ex. |
| 6 | carboxyl group | 5 | 0.3 | 1376 | 42 | Co. Ex. |

S. No = sample number
Ex = Example
Co. Ex = Comparative Example

Then, magnetic property of the powder magnetic core of each sample is measured. The magnetic loss is measured by using an alternating BH curve measurement device in the conditions of 100 mT and 120 kHz. The relative magnetic permeability is obtained from an inductance value measured by using an LCR meter in the conditions of 120 kHz and superposition magnetic field of 52 Oe. Furthermore, as an indicator of the mechanical strength, a plate-like sample having a length of 18 mm, a width of 5 mm, and a thickness of 4 mm is molded at molding pressures described in Table 4, heat-treated at 800° C. for 60 minutes, and subjected to a destruction test by the 3-point bending test. Note here that the bending strength is measured by the same method as in Example 1. The measurement results are shown in Table 4.

From Table 4, at the molding pressures of 6 ton/cm² or more, the bending strength becomes higher. From this Example, in order to further enhance the mechanical strength, it is preferable that a pressure at the time of press-molding is made to be 6 ton/cm² or more.

The same effect can be obtained when silicone resin including mercapto groups, silanol groups, and amino groups, other than carboxyl groups, is used.

### Example 5

In Examples and Comparative Examples, as soft-magnetic metal powder, Fe—Al—Si alloy powder produced by a gas atomization method and having an average particle diameter of 30 μm is used. Samples Nos. 1 to 6 are produced by mixing 0.2 wt % of silicone resin including amino groups, a small amount of toluene, 0.1 wt % of butyral resin and a small amount of alcohol with the soft-magnetic metal powder. In Examples, the heat-treating temperature is set at 700° C. or higher and 1000° C. or lower, and in Comparative Example, the heat-treating temperature is set at 650° C. or 1050° C.

These samples (mixtures) are dried at 90° C. for 90 minutes, milled, and then classified into 100 μm or more and 500 μm or less so as to obtain a powder body for molding.

Each sample is molded into a toroidal shape having an outer diameter of 14 mm, an inner diameter of 10 mm, and a thickness of 2 mm, at a molding pressure of 10 ton/cm², and heat-treated at temperatures described in Table 5 for 60 minutes.

TABLE 5

| | functional | | | | | |
|---|---|---|---|---|---|---|
| | group | heat- | | | | |
| | included in | treating | bending | magnetic | relative | |
| S. | added silicone | temperature | strength | loss | magnetic | |
| No. | resin | (° C.) | (MPa) | (kW · m⁻³) | permeability | — |
| 1 | amino group | 700 | 3.6 | 338 | 35 | Ex. |
| 2 | amino group | 800 | 3.6 | 307 | 35 | Ex. |
| 3 | amino group | 900 | 3.7 | 282 | 36 | Ex. |
| 4 | amino group | 1000 | 3.6 | 278 | 36 | Ex. |
| 5 | amino group | 650 | 3.7 | 733 | 32 | Co. Ex. |
| 6 | amino group | 1050 | 4.2 | 788 | 32 | Co. Ex. |

S. No = sample number
Ex = Example
Co. Ex = Comparative Example

Then, magnetic property of the powder magnetic core of each sample is measured. The magnetic loss is measured by using an alternating BH curve measurement device in the conditions of 100 mT and 120 kHz. The relative magnetic permeability is obtained from an inductance value measured by using an LCR meter in the conditions of 120 kHz and superposition magnetic field of 52 Oe. Furthermore, the bending strength is obtained as an indicator of the mechanical strength, in which a plate-like sample having a length of 18 mm, a width of 5 mm, and a thickness of 4 mm is molded at molding pressure of 10 ton/cm², heat-treated at temperatures described in Table 5 for 60 minutes, and subjected to a destruction test by the 3-point bending test. The bending strength is measured by the same method as in Example 1. The results are shown in Table 5.

As is apparent from Table 5, when the heat-treating temperature is in a range of 700° C. or higher and 1000° C. or lower, lower magnetic loss is achieved.

The same effect can be obtained when silicone resin including mercapto groups, carboxyl groups, and silanol groups, other than amino groups, is used.

### Example 6

In this Example, as soft-magnetic metal powder, Fe powder produced by a water atomization method and having an average particle diameter of 8 μm is used. Samples Nos. 1 to 6 are produced by mixing 0.2 wt % of silicone resin including silanol groups, and a small amount of toluene with the soft-magnetic metal powder. The silicone resin has different pencil hardness as shown in Table 6.

TABLE 6

| | functional group | | | |
|---|---|---|---|---|
| S. | included in added | pencil hardness of | fluidity | |
| No. | silicone resin | added silicone resin | (sec/50 g) | — |
| 6 | silanol group | 6B | 58.7 | Co. Ex. |
| 1 | silanol group | 5B | 49.2 | Ex. |
| 2 | silanol group | HB | 47.3 | Ex. |
| 3 | silanol group | F | 47.2 | Ex. |
| 4 | silanol group | 5H | 47.0 | Ex. |
| 5 | silanol group | 6H | 46.4 | Ex. |

S. No = sample number
Ex = Example
Co. Ex = Comparative Example

These samples (mixtures) are dried at 80° C. for 60 minutes, milled, and classified into 100 μm or more and 500 μm or less so as to obtain a powder body for molding.

In the above-mentioned powder body, according to JISZ2502, evaluation results of time for which 50 g of powder body drops from a funnel is defined as fluidity are shown in Table 6.

From Table 6, in sample No. 6, the fluidity of the powder body is increased. Thus, it is preferable that the pencil hardness of silicone resin is 5B or more.

From Table 3 of Example 3, in order to obtain high mechanical strength, it is preferable that the pencil hardness of silicone resin is 4H or less. Therefore, in order to obtain high mechanical strength and appropriate fluidity, it is preferable that the pencil hardness of silicone resin is 5B or more and 4H or less.

The same effect can be obtained when silicone resin including mercapto groups, carboxyl groups, and amino groups, other than silanol groups, is used.

As described above, according to this exemplary embodiment, dispersion property of silicone resin with respect to the soft-magnetic metal powder is enhanced, and thus powder magnetic core, which is excellent in productivity, and has high mechanical strength, low magnetic loss, and high magnetic permeability, is obtained. Furthermore, a production method for powder magnetic core of the present invention has high productivity without increasing steps and material.

### INDUSTRIAL APPLICABILITY

A powder magnetic core in accordance with this exemplary embodiment is excellent in productivity, and has small size and high efficiency, high yield at the time of manufacture, and high reliability. Therefore, the powder magnetic core is useful in various electronic apparatus.

1. A production method for a powder magnetic core, the method comprising:
mixing soft-magnetic metal powder with silicone resin including at least one functional group selected from carboxyl groups, mercapto groups, amino groups, and silanol groups for forming a mixture in which a surface of the soft-magnetic metal powder is coated with the silicone resin;
drying the mixture for forming dry powder;
pressurizing the dry powder for forming a compact; and
heat-treating the compact.

2. The production method for a powder magnetic core of claim 1, wherein pencil hardness of the silicone resin between the forming of the dry powder and the forming of the compact is 5B or more and 4H or less.

3. The production method for a powder magnetic core of claim 1, wherein the silicone resin is mixed in 0.01 wt % or more and 5 wt % or less with respect to the soft-magnetic metal powder.

4. The production method for a powder magnetic core of claim 1, wherein in the pressurizing of the dry powder for forming the compact, the dry powder is pressurized at a pressure of 6 ton/cm² or more and 20 ton/cm² or less.

5. The production method for a powder magnetic core of claim 1, wherein in the heat-treating of the compact, a heat-treating temperature is 700° C. or higher and 1000° C. or lower.

6. The production method for a powder magnetic core of claim 1, further comprising classifying the dry powder between the forming of the dry powder and the forming of the compact.

7. The production method for a powder magnetic core of claim 6, further comprising milling the dry powder between the forming of the dry powder and the classifying of the dry powder.

8. A powder magnetic core formed by mixing soft-magnetic metal powder and silicone resin with each other so as to form a mixture in which a surface of the soft-magnetic metal powder is coated with the silicone resin, pressure-molding the mixture, followed by heat treatment,
wherein the silicone resin includes at least one functional group selected from carboxyl groups, mercapto groups, amino groups, and silanol groups.

9. The powder magnetic core of claim 8, wherein pencil hardness of the silicone resin before the pressure-molding is 5B or more and 4H or less.

10. The powder magnetic core of claim 8, wherein the silicone resin is mixed in 0.01 wt % or more and 5 wt % or less with respect to the soft-magnetic metal powder.
